(19) United States
(12) Patent Application Publication
(10) Pub. No.: US 2025/0034290 A1
(43) Pub. Date: Jan. 30, 2025

(54) Functional Cyclic Olefin Polymer, Process for Obtaining the Same and Compositions Containing the Same

(71) Applicant: Exxonmobil Chemical Patents Inc., Baytown, TX (US)

(72) Inventors: Qingshuang Liu, Shanghai (CN); Saifudin M. Abubakar, Singapore (SG); Yi Zhou, Shanghai (CN); Ke Ran Chen, Shanghai (CN); Yingcheng Pan, Shanghai (CN); Tian Li, Shanghai (CN); Yang Wang, Shanghai (CN)

(21) Appl. No.: 18/712,991

(22) PCT Filed: Oct. 31, 2022
(86) PCT No.: PCT/US2022/078981

§ 371 Date: May 23, 2024

Related U.S. Application Data
(60) Provisional application No. 63/286,138, filed on Dec. 6, 2021.

(51) Int. Cl. C08F 8/04

(52) U.S. Cl. CPC C08F 8/04; C08F 2810/00

(57) ABSTRACT

The present invention relates to a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the amount of the monomeric unit A′ is in the range of from 20% to 100% by mole, 50% to 100% by mole, from 60% to 100% by mole, or from 70% to 100% by mole, based on the total amount of the monomeric units of the cyclic olefin polymer. The present invention further relates to a process for producing the functional cyclic olefin polymer, a composition comprising the functional cyclic olefin polymer, and the use of the functional cyclic olefin polymer. The functional cyclic olefin polymer of the present invention exhibits improved properties, especially in terms of mechanical properties and barrier properties.

### CROSS-REFERENCE TO RELATED APPLICATIONS

This application claims the benefit of and priority to U.S. Provisional Application No. 63/286,138 filed Dec. 6, 2021, the disclosure of which is incorporated herein by reference.

### FIELD OF THE INVENTION

This invention relates generally to a functional cyclic olefin polymer obtained from ring-opening metathesis polymerization and subsequent hydrogenation, a process for obtaining the same, and a composition containing the same.

### BACKGROUND OF THE INVENTION

Ring-opening metathesis polymerization (ROMP) of cyclic olefins is a powerful way for developing new materials. Ring-opening metathesis polymerization and subsequent hydrogenation provide an opportunity to design polymer network at the monomer level, thereby to tailor properties, such as mechanical properties, of the polymer. Resins made from ring-opening metathesis polymerization and subsequent hydrogenation generally provide better properties as desired.

In the art, there is still a need to further develop polymers having desired properties via ring-opening metathesis polymerization, for various applications.

### SUMMARY OF THE INVENTION

In a first general aspect, this disclosure provides a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the amount of the monomeric unit A′ is in the range of from 20% to 100% by mole, 50% to 100% by mole, from 60% to 100% by mole, or from 70% to 100% by mole, based on the total amount of the monomeric units of the cyclic olefin polymer.

In a second general aspect, this disclosure provides a process for producing the functional cyclic olefin polymer of the present invention, comprising;
(i) polymerizing a monomer through ring-opening metathesis polymerization in the presence of a catalyst, to form a cyclic olefin polymer, wherein the monomer comprises at least a monomer A having a norbornene ring and a polar functional group; and
(ii) hydrogenating the cyclic olefin polymer.

In a third general aspect, this disclosure provides a composition containing the functional cyclic olefin polymer of the present invention.

This disclosure also provides the use of the functional cyclic olefin polymer of the present invention.

The functional cyclic olefin polymer of the present invention has improved properties, especially in terms of mechanical properties and barrier properties.

### BRIEF DESCRIPTION OF THE DRAWING

FIG. 1 shows the tensile properties of each sample of example 6.

FIG. 2 shows the polar forces of each sample of example 6.

FIG. 3 shows the comparison of impact properties of the functional cyclic olefin polymer of present invention and commercial cyclic olefin polymers in example 6.

### DETAILED DESCRIPTION OF THE INVENTION

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

All numerical values within the present disclosure are modified by “about” the indicated value, taking into account experimental error and variations that would be expected by a person having ordinary skill in the art.

The articles “a”, “an” and “the” mean one or more of the species designated by the term following said article.

As used herein, the term “copolymer” is meant to include polymers having two or more monomers, and may refer to interpolymers, terpolymers, etc. The term “polymer” as used herein includes, but is not limited to, homopolymers, copolymers, terpolymers, etc., and alloys thereof. The term “polymer” shall further include all possible geometrical configurations unless otherwise specifically stated. Such configurations may include isotactic, syndiotactic and atactic symmetries.

As used herein, the term “monomer”, when used alone, is meant to include all the compounds that will be polymerized in a polymerization process. In the present invention, the term “monomer” encompasses monomer A and a comonomer (if any).

### Cyclic Olefin Polymer

The cyclic olefin polymer of the present invention comprises at least a monomeric unit A′ derived from a monomer A having a norbornene ring and a polar functional group, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

The polar functional group in monomer A of the present invention may be selected from aldehyde groups, alkylcarbonyloxy groups, arylcarbonyloxy groups, alkoxycarbonyl groups, aryloxycarbonyl groups, alkoxysilyl, aryloxysilyl, amine groups, amide groups, imide groups, hydroxy, hydroxyalkyl groups, hydroxyaryl groups, carboxyl groups, anhydride groups, halogen groups, cyano groups or a combination thereof.

In some embodiment of the invention, the polar functional group in monomer A of the present invention may be selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof.

In some embodiments of the invention, the polar functional group in monomer A of the present invention may be selected from hydroxy.

In the cyclic olefin polymer of the present invention, the amount of the monomeric unit A′ is in the range from 20% to 100% by mole, 50% to 100% by mole, from 55% to 100% by mole, from 60% to 100% by mole, from 65% to 100% by mole, from 70% to 100% by mole, from 75% to 100% by mole, from 80% to 100% by mole, from 85% to 100% by mole, from 90% to 100% by mole, or from 95% to 100% by mole, based on the total amount of the monomeric units of the cyclic olefin polymer.

### Monomer Having a Norbornene Ring and a Polar Functional Group

In the present invention, monomers having a norbornene ring and a polar functional group are used as monomer A.

A monomer having Formula (I) may be used as monomer A of the present invention:

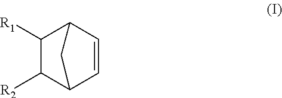

wherein R₁ and R₂, independent from each other, represent a polar functional group having a halogen, silicon, oxygen or nitrogen atom; a hydrogen atom; or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group.

In some embodiments of the present invention, the polar functional group in the monomer having Formula (I) is selected from C₁-C₂₀-alkanal groups; such as —CHO, —CH₂CHO, —C₂H₄CHO, —C₃H₆CHO, —C₄H₈CHO, —C₅H₁₀CHO, —C₆H₁₂CHO, —C₇H₁₄CHO, —C₈H₁₆CHO, —C₉H₁₈CHO, —C₁₀H₂₀CHO, —C₁₂H₂₄CHO, —C₁₄H₂₈CHO, —C₁₆H₃₂CHO, —C₁₈H₃₆CHO, —C₂₀H₄₀CHO; C₆-C₂₀-aryl aldehyde groups; hydroxy-C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; imide groups; carboxyl, carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof, hydroxy; C₁-C₂₀-alkoxysilyl groups, such as, methoxysilyl, ethoxysilyl, propoxysilyl, butoxysilyl, pentoxysilyl, hexyloxysilyl, heptyloxysilyl, octyloxysilyl, C₁₀-alkoxysilyl, C₁₂-alkoxysilyl, C₁₄-alkoxysilyl, C₁₆-alkoxysilyl, C₁₈-alkoxysilyl, and C₂₀-alkoxysilyl; C₆-C₂₀-aryloxysilyl; C₁-C₂₀-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, C₁₈-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, C₁₈-alkoxycarbonyl, and C₂₀-alkoxycarbonyl; C₆-C₂₀-aryloxycarbonyl; halogen group such as fluorine group, chlorine group; cyano; or a combination thereof.

In some embodiments of the present invention, the polar functional group in the monomer having Formula (I) is selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; carboxyl; carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof; C₁-C₂₀-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, Cis-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, Cis-alkoxycarbonyl, and C₂₀-alkoxycarbonyl; C₆-C₂₀-aryloxycarbonyl; or a combination thereof.

In some embodiments of the present invention, the polar functional group in the monomer having Formula (I) is selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; or a combination thereof.

As the monomer having Formula (I) of the present invention, non-limiting examples include 5-norbornene-2-methanol, 5-norbornene-2,3-dicarboximide, 5-norbornene-2,3-dicarboxylic anhydride, 5-norbornene-2-carboxylic acid, 5-norbornene-2,3-dicarboxylic acid, 2,2-bis(hydroxymethyl)-5-norbornene, N-hydroxy-5-norbornene-2,3-dicarboxylic acid imide, 5-norbornene-2-carboxaldehyde, 5-norbornene-2-ol, methyl 5-norbornene-2-carboxylate, 5-norbornene-2-yl acetate. In an embodiment of the present invention, the monomer having Formula (I) of the present invention is 5-norbornene-2-methanol.

Monomers having a polar functional group and more than two rings including a norbornene ring may also be used in the present invention as monomer A. In some embodiments of the invention, dicyclopentadiene having a polar functional group is used as monomer A. For example, in some embodiments of the invention, a dicyclopentadiene having a polar functional group is used as monomer A, wherein the polar functional group is selected from C₁-C₂₀-alkanal groups; such as —CHO, —CH₂CHO, —C₂H₄CHO, —C₃H₆CHO, —C₄H₈CHO, —C₅H₁₀CHO, —C₆H₁₂CHO, —C₇H₁₄CHO, —C₈H₁₆CHO, —C₉H₁₈CHO, —C₁₀H₂₀CHO, —C₁₂H₂₄CHO, —C₁₄H₂₈CHO, —C₁₆H₃₂CHO, —C₁₈H₃₆CHO, —C₂₀H₄₀CHO; C₆-C₂₀-aryl aldehyde groups; hydroxy-C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; imide groups; carboxyl, carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof, hydroxy; C₁-C₂₀-alkoxysilyl groups, such as, methoxysilyl, ethoxysilyl, propoxysilyl, butoxysilyl, pentoxysilyl, hexyloxysilyl, heptyloxysilyl, octyloxysilyl, C₁₀-alkoxysilyl, C₁₂-alkoxysilyl, C₁₄-alkoxysilyl, C₁₆-alkoxysilyl, C₁₈-alkoxysilyl, and C₂₀-alkoxysilyl; C₆-C₂₀-aryloxysilyl; C₁-C₂₀-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, C₁₈-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, C₁₈-alkoxycarbonyl, and C₂₀-alkoxycarbonyl; or a combination thereof.

In some embodiments of the present invention, a dicyclopentadiene having a polar functional group is used as monomer A, wherein the polar functional group selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; carboxyl; carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof, C₁-C₂₀-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, C₁₈-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, C₁₈-alkoxycarbonyl, and C₂₀-alkoxycarbonyl; C₆-C₂₀-aryloxycarbonyl; or a combination thereof.

In some embodiments of the present invention, a dicyclopentadiene having a polar functional group is used as monomer A, wherein the polar functional group selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl, or a combination thereof.

Monomers having Formula (II) may also be used as monomer A of the present invention.

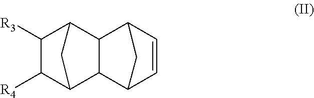

wherein R₃ and R₄, independent from each other, represent a polar functional group having a halogen, silicon, oxygen or nitrogen atom; a hydrogen atom; or a hydrocarbon group having 1 to 20 carbon atoms, such as 2, 3, 4, 5, 6, 7, 8, 9, 10, 12, 15, 16 and 18 carbon atoms, wherein at least one of R₃ and R₄ represents a polar functional group. In some embodiments of the invention, the polar functional group is selected from C₁-C₂₀-alkanal groups; such as —CHO, —CH₂CHO, —C₂H₄CHO, —C₃H₆CHO, —C₄H₈CHO, —C₅H₁₀CHO, —C₆H₁₂CHO, —C₇H₁₄CHO, —C₈H₁₆CHO, —C₉H₁₈CHO, —C₁₀H₂₀CHO, —C₁₂H₂₄CHO, —C₁₄H₂₈CHO, —C₁₆H₃₂CHO, —C₁₈H₃₆CHO, —C₂₀H₄₀CHO; C₆-C₂₀-aryl aldehyde groups; hydroxy-C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; imide groups; carboxyl, carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof, hydroxy; C₁-C₂₀-alkoxysilyl groups, such as, methoxysilyl, ethoxysilyl, propoxysilyl, butoxysilyl, pentoxysilyl, hexyloxysilyl, heptyloxysilyl, octyloxysilyl, C₁₀-alkoxysilyl, C₁₂-alkoxysilyl, C₁₄-alkoxysilyl, C₁₆-alkoxysilyl, C₁₈-alkoxysilyl, and C₂₀-alkoxysilyl; C₆-C₂₀-aryloxysilyl; C₁-C₂O-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, C₁₈-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, C₁₈-alkoxycarbonyl, and C₂₀-alkoxycarbonyl; C₆-C₂₀-aryloxycarbonyl; halogen group such as fluorine group, chlorine group; cyano; or a combination thereof.

In some embodiments of the present invention, the polar functional group in the monomer having Formula (II) is selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl; carboxyl; carboxyl-C₁-C₂₀-alkyl, such as carboxylmethyl, carboxylethyl, carboxylpropyl, carboxylbutyl, carboxylpentyl, carboxylhexyl, carboxylheptyl, carboxyloctyl, carboxylnonyl, carboxyl-C₁₂-alkyl, carboxyl-C₁₄-alkyl, carboxyl-C₁₆-alkyl, carboxyl-C₁₈-alkyl, and carboxyl-C₂₀-alkyl, carboxyl-C₆-C₂₀-aryl, and anhydride groups thereof, C₁-C₂₀-alkylcarbonyloxy groups, such as acetoxy, ethylcarbonyloxy, propylcarbonyloxy, butylcarbonyloxy, pentylcarbonyloxy, hexylcarbonyloxy, heptylcarbonyloxy, octylcarbonyloxy, C₁₀-alkylcarbonyloxy, C₁₂-alkylcarbonyloxy, C₁₄-alkylcarbonyloxy, C₁₆-alkylcarbonyloxy, C₁₈-alkylcarbonyloxy, and C₂₀-alkylcarbonyloxy; C₆-C₂₀-arylcarbonyloxy groups; C₁-C₂₀-alkoxycarbonyl groups, such as, methoxycarbonyl, ethoxycarbonyl, propoxycarbonyl, butoxycarbonyl, pentoxycarbonyl, hexyloxycarbonyl, heptyloxycarbonyl, octyloxycarbonyl, C₁₀-alkoxycarbonyl, C₁₂-alkoxycarbonyl, C₁₄-alkoxycarbonyl, C₁₆-alkoxycarbonyl, C₁₈-alkoxycarbonyl, and C₂₀-alkoxycarbonyl; C₆-C₂₀-aryloxycarbonyl; or a combination thereof.

In some embodiments of the present invention, the polar functional group in the monomer having Formula (II) is selected from hydroxy; hydroxy C₁-C₂₀-alkyl, such as hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, and hydroxy-C₂₀-alkyl; hydroxy-C₆-C₂₀-aryl, or a combination thereof.

As the monomer having Formula (II) of the present invention, non-limiting examples include 8-methoxycarbonyl-tetracyclododecene, 8-methyl-8-methoxycarbonyl-tetracyclododecene, 8-hydroxymethyltetracyclododecene, tetracyclododecene-8,9-dicarboxylic acid, tetracyclododecene-8,9-dicarboxylic anhydride, 8-cyanotetracyclododecene, tetracyclododecene-8,9-dicarboxylic acid imide, 8-chlorotetracyclododecene, 8-trimethoxysilyl-tetracyclododecene.

### Comonomer

The cyclic olefin polymer of the present invention may further comprise a monomeric unit B′ derived from cyclic olefins other than monomer A. These cyclic olefins do not have a functional group other than olefinic double bond and are used as the comonomer of the cyclic olefin polymer of the present invention.

In some embodiments of the invention, the comonomer of the present invention is selected from cyclic olefins, including cyclic olefins having 4 to 20 carbon atoms, preferably 4 to 10 carbon atoms, and derivatives and isomers of these cyclic olefins and cyclic diolefins.

As the comonomer of the present invention, non-limiting examples include norbornene, norbornadiene, cyclopropene, cyclobutene, cyclopentene, methylcyclopentene, cyclohexene, methylcyclohexene, cycloheptene, cyclooctene (cis and trans), cyclopentadiene, cyclohexadiene, methylcyclohexadiene, cyclooctadiene, methylcyclooctadiene and phenylcyclooctadiene.

Monomer having Formula (III) may be used as the comonomer of the present invention:

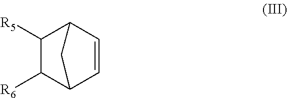

wherein R₅ and R₆, independent from each other, represent hydrogen atom, a hydrocarbon group having 1 to 20 carbon atoms, such as 2, 3, 4, 5, 6, 7, 8, 9, 10, 12, 15, 16 and 18, carbon atoms, such as C₁-C₁₅ alkyl, C₂-C₁₅ alkenyl, C₆-C₁₅ aryl, wherein R₅ and R₆ may form together a ring.

As the monomer having Formula (III), non-limiting examples include norbornene, 2-methyl-5-norbornene, 2-ethyl-5-norbornene, 2-butyl-5-norbornene, 2-hexyl-5-norbornene.

In some embodiments of the invention, dicyclopentadiene or dicyclopentadiene substituted with a hydrocarbon group having 1 to 20 carbon atoms, such as 2, 3, 4, 5, 6, 7, 8, 9, 10, 12, 15, 16 and 18, carbon atoms, such as C₁-C₁₅ alkyl, C₂-C₁₅ alkenyl, C₆-C₁₅ aryl, may be used as the comonomer of the present invention.

Monomer having Formula (IV) may be used as the comonomer of the present invention:

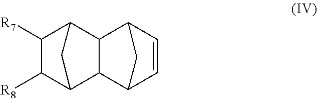

wherein R₇ and R₈, independent from each other, represent, a hydrogen atom, a hydrocarbon group having 1 to 20 carbon atoms, such as 2, 3, 4, 5, 6, 7, 8, 9, 10, 12, 15, 16 and 18, carbon atoms, such as C₁-C₁₅ alkyl, C₂-C₁₅ alkenyl, C₆-C₁₅ aryl, wherein R₇ and R₈ may form together a ring.

As comonomer of Formula (IV), non-limiting examples include 8-methyl-tetracyclododecene, 8-ethyltetracyclododecene, 8-cyclohexyltetracyclododecene and 8-cyclopentyl-tetracyclododecene.

The comonomers suitable for the present invention may be used in any appropriate combination.

### Functional Cyclic Olefin Polymer

The functional cyclic olefin polymer of the present invention is obtained from hydrogenation of the cyclic olefin polymer of the present invention.

The weight-average molecular weight (M_{w}) of the functional cyclic olefin polymer of the present invention can be between 10,000 Da and 2,000,000 Da. For example, the functional cyclic olefin polymer can have an M_{w} of 2,000,000 Da, 1,950,000 Da, 1,900,000 Da, 1,850,000 Da, 1,800,000 Da, 1,750,000 Da, 1,700,000 Da, 1,650,000 Da, 1,600,000 Da, 1,550,000 Da, 1,500,000 Da, 1,450,000 Da, 1,400,000 Da, 1,350,000 Da, 1,300,000 Da, 1,250,000 Da, 1,200,000 Da, 1,150,000 Da, 1,000,000 Da, 900,000 Da, 800,000 Da, 700,000 Da, 600,000 Da, 500,000 Da, 400,000 Da, 300,000 Da, 200,000 Da, 100,000 Da, 90,000 Da, 80,000 Da, 70,000 Da, 60,000 Da, 50,000 Da, 40,000 Da, 30,000 Da, 20,000 Da, 10,000 Da, or of any M_{w} between these values, as obtained by gel permeation chromatography (GPC) according to DIN 55672-1. The polydispersity index (PDI) (M_{w}/Mₙ) of the functional cyclic olefin polymer of the present invention can be between 1 and 10. For example, the functional cyclic olefin polymer of the present invention can have a PDI of 1, 1.5, 2, 2.5, 3, 3.5, 4, 4.5, 5, 5.5, 6, 6.5, 7, 7.5, 8, 8.5, 9, 9.5, or 10, or of any M_{w}/Mₙ between these values.

The glass transition temperature (Tg) of the functional cyclic olefin polymer of the present invention may be from −70° C. to 300° C., or from −30° C. to 300° C., or from 0° C. to 300° C., or from 30° C. to 280° C., or from 100° C. to 250° C., for example from −70° C. to 250° C., or from −70° C. to 100° C., or from −70° C. to 50° C., or from −70° C. to 100° C., or from 0° C. to 300° C., or from 0° C. to 260° C., or from 0° C. to 250° C., or from 0° C. to 240° C., or from 0° C. to 230° C., or from 0° C. to 220° C., or from 0° C. to 210° C., or from 0° C. to 200° C., or from 0° C. to 180° C., or from 0° C. to 160° C., or from 0° C. to 150° C., or from 0° C. to 140° C., or from 0° C. to 120° C., or from 0° C. to 110° C., or from 0° C. to 100° C., or from 0° C. to 80° C., or from 0° C. to 60° C., or from 0° C. to 50° C., or from 0° C. to 30° C., or from 30° C. to 260° C., or from 30° C. to 250° C., or from 30° C. to 240° C., or from 30° C. to 230° C., or from 30° C. to 220° C., or from 30° C. to 210° C., or from 30° C. to 200° C., or from 30° C. to 180° C., or from 30° C. to 160° C., or from 30° C. to 150° C., or from 30° C. to 140° C., or from 30° C. to 120° C., or from 30° C. to 110° C., or from 30° C. to 100° C., or from 30° C. to 80° C., or from 30° C. to 60° C., or from 30° C. to 50° C., or from 30° C. to 40° C., 40° C. to 260° C., or from 40° C. to 250° C., or from 40° C. to 240° C., or from 40° C. to 230° C., or from 40° C. to 220° C., or from 40° C. to 210° C., or from 40° C. to 200° C., or from 40° C. to 180° C., or from 40° C. to 160° C., or from 40° C. to 150° C., or from 40° C. to 140° C., or from 40° C. to 120° C., or from 40° C. to 110° C., or from 40° C. to 100° C., or from 40° C. to 80° C., or from 40° C. to 60° C., or from 40° C. to 50° C., or from 50° C. to 260° C., or from 50° C. to 250° C., or from 50° C. to 240° C., or from 50° C. to 230° C., or from 50° C. to 220° C., or from 50° C. to 210° C., or from 50° C. to 200° C., or from 50° C. to 180° C., or from 50° C. to 160° C., or from 50° C. to 150° C., or from 50° C. to 140° C., or from 50° C. to 120° C., or from 50° C. to 110° C., or from 50° C. to 100° C., or from 50° C. to 80° C., or from 50° C. to 60° C., or from 60° C. to 80° C., or from 90° C. to 120° C., or from 130° C. to 180° C., or from 190° C. to 220° C., or from 230° C. to 250° C., or from 260° C. to 300° C., or any value between these ranges. The glass transition temperature is measured by raising the temperature at 10° C./min using a differential scanning calorimeter (DSC) or is measured with a temperature ramp of 5° C./min within the range from −135° C. to 300° C. using dynamic mechanical thermal analysis (DMTA).

The functional cyclic olefin polymer of the present invention has polarity characterized by polar force. The polar force of the functional cyclic olefin polymer of the present invention can be between 0.5 to 20 mN/m, such as 0.6 mN/m, 0.8 mN/m, 1.0 mN/m, 1.5 mN/m, 2.0 mN/m, 2.5 mN/m, 3.0 mN/m, 3.5 mN/m, 4.0 mN/m, 4.5 mN/m, 5.0 mN/m, 5.5 mN/m, 6.0 mN/m, 6.5 mN/m, 7.0 mN/m, 7.5 mN/m, 8.0 mN/m, 8.5 mN/m, 9.0 mN/m, 9.5 mN/m, 10.0 mN/m, 10.5 mN/m, 11.0 mN/m, 11.5 mN/m, 12.0 mN/m, 12.5 mN/m, 13.0 mN/m, 13.5 mN/m, 14.0 mN/m, 14.5 mN/m, 15.0 mN/m, 15.5 mN/m, 16.0 mN/m, 16.5 mN/m, 17.0 mN/m, 17.5 mN/m, 18.0 mN/m, 18.5 mN/m, 19.0 mN/m, 19.5 mN/m, or any value between these values, which is determined according to ASTM D7490-13 using water contact angle, wherein water contact angle is measured according to ASTM D 5946-04. In some preferable embodiments of the invention, the polar force of the functional cyclic olefin polymer of the present invention is in the range from 0.5 to 15 mN/m, more preferably in the range from 0.5 to 10 mN/m.

The decomposition temperature of the functional cyclic olefin polymer of the present invention can be between 250° C. to 500° C., such as 260° C., 300° C., 320° C., 350° C., 360° C., 370° C., 380° C., 390° C., 400° C., 410° C., 420° C., 430° C., 440° C., 450° C., 460° C., 470° C., 480° C., 490° C., 500° C., or any decomposition temperature between these values. In some embodiments of the invention, the decomposition temperature of the functional cyclic olefin polymer of the present invention is in the range from 330° C. to 480° C., such as in the range from 350° C. to 450° C. The decomposition temperature of the functional cyclic olefin polymer of the present invention is measured by raising the temperature at 10° C./min using a thermogravimetric analyzer (TGA).

### Process for the Preparation of the Functional Cyclic Olefin Polymer

The functional cyclic olefin polymer of the present invention is prepared by ring-opening metathesis polymerization, and then hydrogenation of the obtained cyclic olefin polymer.

In particular, the functional cyclic olefin polymer of the present invention is prepared by a process comprising;
(i) polymerizing a monomer through ring-opening metathesis polymerization in the presence of a catalyst, to form a cyclic olefin polymer, wherein the monomer comprises at least a monomer A having a norbornene ring and a polar functional group as mentioned above; and
(ii) hydrogenating the cyclic olefin polymer.

Optionally, the monomer used in step (i) further comprises a comonomer as mentioned above. The amount of comonomer is in the range from 0% by mole to 80% by mole, such as 5% by mole, 10% by mole, 15% by mole, 20% by mole, 25% by mole, 30% by mole, 35% by mole, 40% by mole, 45% by mole, 50% by mole, 60% by mole, 70% by mole, and any amount between these amounts, based on the total amount of the monomer used in step (i).

Conditions for ring-opening metathesis polymerization in step (i) may be determined by a skilled person according to practical operation. The polymerization temperature of the present invention is not particularly limited, and may be selected from −30° C. to 200° C., such as −25° C., −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 110° C., 120° C., 130° C., 140° C., 150° C., 160° C., 170° C., 180° C., 190° C., and any temperature between these values. In an embodiment of the present invention, the polymerization temperature of the present invention is in the range from 0° C. to 180° C. In an embodiment of the present invention, the polymerization temperature of the present invention is in the range from −10° C. to 100° C., such as 20° C. to 80° C.

The polymerization time of the present invention is usually in the range from 1 minute to 100 hours, such as 1 minute to 100 minutes, 5 minutes to 60 minutes, 10 minutes to 50 minutes, 30 minutes to 90 minutes, 50 minutes to 90 minutes, 2 minutes to 100 minutes, 3 minutes to 100 minutes, 10 minutes to 100 minutes, 15 minutes to 100 minutes, 20 minutes to 100 minutes, 10 minutes to 90 minutes, 15 minutes to 90 minutes, 20 minutes to 90 minutes, 2 hours to 80 hours, 10 hours to 80 hours, 15 hours to 80 hours, 20 hours to 80 hours, 2 hours to 70 hours, 10 hours to 70 hours, 15 hours to 70 hours, 20 hours to 70 hours, 2 hours to 60 hours, 10 hours to 60 hours, 15 hours to 60 hours, 20 hours to 60 hours, 30 hours to 60 hours, 40 hours to 80 hours, 60 hours to 90 hours, 60 hours to 100 hours, and any time between these values. In an embodiment of the present invention, the polymerization time of the present invention is in the range from 10 minutes to 100 minutes, such as in the range from 10 minutes to 90 minutes.

In step (i), the ring-opening metathesis polymerization is carried out in the presence of a catalyst. The catalyst for ring-opening metathesis polymerization of the present invention is a compound that catalyzes the ring-opening metathesis polymerization, and will be selected by a skilled person.

The catalysts suitable for the present invention in step (i) may include metal compounds such as compounds of titanium (Ti), molybdenum (Mo), tungsten (W), rhenium (Re), and ruthenium (Ru).

In some embodiments of the invention, the ring-opening metathesis polymerization catalyst is represented by the formula:

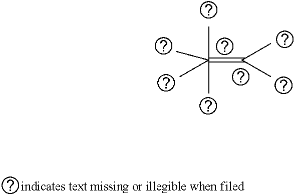

where:
   M is a Group 8 metal, preferably Ru or Os, more preferably Ru;
   X and X¹ are, independently, any anionic ligand, preferably a halogen (preferably chlorine), an alkoxide or a triflate, or X and X¹ may be joined to form a dianionic group and may form a single ring of up to 30 non-hydrogen atoms or a multinuclear ring system of up to 30 non-hydrogen atoms;
   L and L¹ are, independently, a neutral two electron donor, preferably a phosphine or a N-heterocyclic carbene, L and L¹ may be joined to form a single ring of up to 30 non-hydrogen atoms or a multinuclear ring system of up to 30 non-hydrogen atoms;
   L and X may be joined to form a multidentate monoanionic group and may form a single ring of up to 30 non-hydrogen atoms or a multinuclear ring system of up to 30 non-hydrogen atoms;
   L¹ and X¹ may be joined to form a multidentate monoanionic group and may form a single ring of up to 30 non-hydrogen atoms or a multinuclear ring system of up to 30 non-hydrogen atoms;
   R and R¹ are, independently, hydrogen, halogen, or substituted or unsubstituted C₁ to C₂₀ hydrocarbyl (preferably substituted or unsubstituted C₁ to C₂₀ alkyl or a substituted or unsubstituted C₆ to C₂₀ aryl) which may contain at least one atom selected from halogen, oxygen, nitrogen, sulfur, phosphorus and silicon atoms;
   R¹ and L¹ or X¹ may be joined to form a single ring of up to 30 non-hydrogen atoms or a multinuclear ring system of up to 30 non-hydrogen atoms; and
   R and L or X may be joined to form a single ring of up to 30 non-hydrogen atoms or a multinuclear ring system of up to 30 non-hydrogen atoms.

Preferred alkoxides include those where the alkyl group is C₁ to C₁₀ hydrocarbyl, preferably C₁ to C₁₀ alkyl group, preferably methyl, ethyl, propyl, butyl, or phenyl, or include those derived from a phenol, substituted phenol (where the phenol may be substituted with up to 1, 2, 3, 4, or 5 C₁ to C₁₂ hydrocarbyl groups).

Preferred phosphines are represented by the formula: PR³′ R⁴′ R⁵′, where R³′ is a secondary alkyl or cycloalkyl (preferably a C₃ to C₁₂ secondary alkyl or cycloalkyl), and R⁴′ and R⁵′ are aryl, C₁ to C₁₀ primary alkyl, secondary alkyl, or cycloalkyl. R⁴′ and R⁵′ may be the same or different. Preferred phosphines include P(cyclohexyl)₃, P(cyclopentyl)₃, and/or P(isopropyl)₃.

Preferred triflates are represented by the Formula:

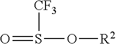

where R² is hydrogen or C₁ to C₃₀ hydrocarbyl group, preferably C₁ to C₁₂ alkyl group, preferably methyl, ethyl, propyl, butyl, or phenyl.

Preferred N-heterocyclic carbenes are represented by the Formula of

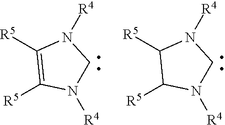

where: NR
   each R⁴ is independently a hydrocarbyl group or substituted hydrocarbyl group having 1 to 40 carbon atoms, preferably methyl, ethyl, propyl, butyl (including isobutyl and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, tolulyl, chlorophenyl, phenol, or substituted phenol; and
   each R⁵ is hydrogen, a halogen, or C₁ to C₁₂ hydrocarbyl group, preferably hydrogen, bromine, chlorine, methyl, ethyl, propyl, butyl, or phenyl. In other useful embodiments, one of the N groups bound to the carbene in these formulae may be replaced with an S, O, or P atom, preferably an S atom.

Other useful N-heterocyclic carbenes include the compounds described in Hermann, W. A. (1996) Chem. Eur. J., v.2, pp. 772 and 1627; Enders, D. et al. (1995)Angew. Chem. Int. Ed., v.34, pg. 1021; Alder R. W. (1996) Angew. Chem. Int. Ed., v.35, pg. 1121; and Bertrand, G. et al. (2000) Chem. Rev., v.100, pg. 39.

In some embodiments of the invention, the ring-opening metathesis polymerization catalyst is one or more of tricyclohexylphosphine[1,3-bis(2,4,6-trimethylphenyl)imidazol-2-ylidene][3-phenyl-1H-inden-1-ylidene]ruthenium(II) dichloride, tricyclohexylphosphine[3-phenyl-1H-inden-1-ylidene][1,3-bis(2,4,6-trimethylphenyl)-4,5-dihydro-imidazol-2-ylidene]ruthenium(II) dichloride, tricyclohexylphosphine[1,3-bis(2,4,6-trimethylphenyl)-4,5-dihydroimidazol-2-ylidene][(phenylthio)methylene]ruthenium(II) dichloride, bis(tricyclohexylphosphine)-3-phenyl-1H-inden-1-ylidene]ruthenium(II) dichloride, 1,3-Bis(2,4,6-trimethylphenyl)-4,5-dihydroimidazol-2-ylidene[2-(i-propoxy)-5-(N,N-dimethylaminosulfonyl)phenyl]methylene ruthenium(II) dichloride, and [1,3-Bis(2,4,6-trimethylphenyl)-2-imidazolidinylidene]-[2-[[(4-methylphenyl)imino]methyl]-4-nitrophenyl]-[3-phenyl-1H-inden-1-ylidene]ruthenium(II) chloride. In some embodiments, the ring-opening metathesis polymerization catalyst is 1,3-Bis(2,4,6-trimethylphenyl)-4,5-dihydroimidazol-2-ylidene[2-(i-propoxy)-5-(N,N-dimethylaminosulfonyl)phenyl]methylene ruthenium(II) dichloride and/or Tricyclohexylphosphine[3-phenyl-1H-inden-1-ylidene][1,3-bis(2,4,6-trimethylphenyl)-4,5-dihydroimidazol-2-ylidene]ruthenium(II) dichloride.

In some embodiments of the invention, the ring-opening metathesis polymerization catalyst is an orgaoruthenium compound having formula of,

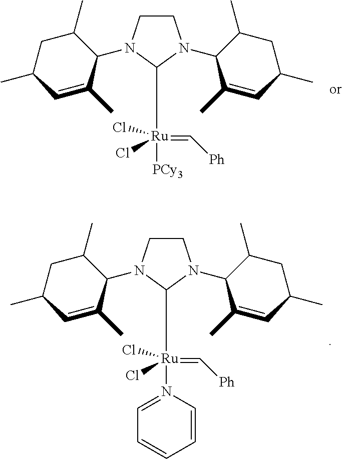

In an embodiment of the invention, the ring-opening metathesis polymerization catalyst is Grubbs 2nd catalyst.

The quantity of the ring-opening metathesis polymerization catalyst that is employed in the process of the invention is any quantity that provides an operable ring-opening metathesis polymerization. Preferably, the ratio of moles of the monomer added in step (i) to moles of the ring-opening metathesis polymerization catalyst is typically not less than 10:1; not less than 100:1; not less than 1,000:1; not less than 10,000:1; not less than 25,000:1; not less than 50,000:1; not less than 100,000:1; not less than 200,000:1; not less than 300,000:1; not less than 400,000:1; not less than 500,000:1; not less than 600,000:1; not less than 700,000:1; not less than 800,000:1; not less than 900,000:1; not less than 1,000,000:1; not less than 1,100,000:1; not less than 1,200,000:1; not less than 1,200,000:1, and not more than 2,000,000:1; not more than 1,800,000:1; not more than 1,600,000:1; not more than 1,400,000:1; not more than 1,200,000:1; not more than 1,000,000:1; not more than 800,000:1; not more than 700,000:1; not more than 600,000:1; not more than 500,000:1. In an embodiment of the invention, the ratio of moles of the monomer added in step (i) to moles of the ring-opening metathesis polymerization catalyst is typically in the range from 100:1 to 2,000,000:1, preferably 500:1 to 1,000,000:1, more preferably 1,000:1 to 500,000:1.

The step (i) of the process of the present invention is carried out in inert solvent. The term “inert solvent” means that the solvent does not react with the catalyst and is capable of dissolving the obtained polymer. Examples of the solvent for step (i) of the process of the present invention include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof such as commercial product (Isopar™); aromatic compounds such as benzene, toluene, mesitylene, ethyl benzene, and xylene; halohydrocarbons such as dichloromethane, ethylene dichloride, tetrachloroethane, chlorobenzene and trichlorobenzene; ethers such as tetrahydrofuran; amides such as dimethylformamide; sulfoxides such as dimethyl sulfoxide.

In some embodiments of the present invention, the solvent for step (i) of the process may be selected from dichloromethane, tetrahydrofuran, dimethylformamide, toluene, or xylene.

For step (i) of the process of the present invention, the concentration of the monomer added for the polymerization is in the range from 0.01 mol/L to 5 mol/L, such as 0.01 mol/L to 4.5 mol/L, 0.01 mol/L to 4 mol/L, 0.01 mol/L to 3.5 mol/L, 0.01 mol/L to 3 mol/L, 0.01 mol/L to 2.5 mol/L, 0.01 mol/L to 2 mol/L, 0.01 mol/L to 1.5 mol/L, 0.01 mol/L to 1 mol/L, 0.01 mol/L to 0.5 mol/L, 0.02 mol/L to 4.5 mol/L, 0.02 mol/L to 4 mol/L, 0.02 mol/L to 3.5 mol/L, 0.02 mol/L to 3 mol/L, 0.02 mol/L to 2.5 mol/L, 0.02 mol/L to 2 mol/L, 0.02 mol/L to 1.5 mol/L, 0.02 mol/L to 1 mol/L, 0.02 mol/L to 0.5 mol/L, 0.03 mol/L to 4.5 mol/L, 0.03 mol/L to 4 mol/L, 0.03 mol/L to 3.5 mol/L, 0.03 mol/L to 3 mol/L, 0.03 mol/L to 2.5 mol/L, 0.03 mol/L to 2 mol/L, 0.03 mol/L to 1.5 mol/L, 0.03 mol/L to 1 mol/L, 0.03 mol/L to 0.5 mol/L, 0.05 mol/L to 4.5 mol/L, 0.05 mol/L to 4 mol/L, 0.05 mol/L to 3.5 mol/L, 0.05 mol/L to 3 mol/L, 0.05 mol/L to 2.5 mol/L, 0.05 mol/L to 2 mol/L, 0.05 mol/L to 1.5 mol/L, 0.05 mol/L to 1 mol/L, 0.05 mol/L to 0.5 mol/L, 0.1 mol/L to 4.5 mol/L, 0.1 mol/L to 4 mol/L, 0.1 mol/L to 3.5 mol/L, 0.1 mol/L to 3 mol/L, 0.1 mol/L to 2.5 mol/L, 0.1 mol/L to 2 mol/L, 0.1 mol/L to 1.5 mol/L, 0.1 mol/L to 1 mol/L, 0.1 mol/L to 0.5 mol/L, or any concentration between these values, based on the total volume of the monomer and the solvent. In an embodiment of the invention, for step (i) of the process, the concentration of the monomer added for the polymerization is in the range from 0.01 mol/L to 2 mol/L, such as 0.05 mol/L to 1 mol/L, based on the total volume of the monomer and the solvent. In some embodiments of the invention, for step (i) of the process, the concentration of the monomer added for the polymerization is in the range from 0.1 mol/L to 0.5 mol/L, based on the total volume of the monomer and the solvent.

At the termination of ring-opening metathesis polymerization, vinyl compounds such as 1-butene, 1-pentene, 1-hexene, 1-octene, ethyl vinyl ether can be added to terminate the polymerization and liberate the polymerization catalyst from a terminal of the polymer chain, thereby enhancing the activity for hydrogenation.

In the process of the present invention, the cyclic olefin polymer obtained from step (i) will undergo hydrogenation in step (ii).

In the process of the present invention, step (ii) may be carried out by adding a hydrogenation agent or by adding a hydrogenation catalyst and hydrogen, to hydrogenate the carbon-carbon double bonds in the cyclic olefin polymer obtained from step (i).

The hydrogenation agent used for hydrogenation of the present invention may be selected by a skilled person. In an embodiment of the present invention, the hydrogenation agent is 1-thia-3,4-diazolidine-2,5-dione. In an embodiment of the present invention, the hydrogenation agent is potassium azodicarboxylate. In an embodiment of the present invention, the hydrogenation agent is arylsulfonyl-hydrazide, such as p-toluenesulfonyl hydrazide (p-TSH), 2,4,6-Trimethylbenzenesulfonyl hydrazide (MSH), 2,4,6-triisopropyl-benzenesulphonylhydrazide (TPSH).

When the hydrogenation of the present invention is carried out by the hydrogenation agent, the hydrogenation agent is added in an amount such that the mole ratio of the hydrogenation agent to unsaturated double bond in the cyclic olefin polymer obtained from step (i) is in the range from 1 to 20 (mol/mol), such as 1 to 18 (mol/mol), 1 to 15 (mol/mol), 1 to 12 (mol/mol), 1 to 10 (mol/mol), 2 to 20 (mol/mol), 2 to 18 (mol/mol), 2 to 15 (mol/mol), 2 to 12 (mol/mol), 2 to 10 (mol/mol), 3 to 20 (mol/mol), 3 to 18 (mol/mol), 3 to 15 (mol/mol), 3 to 12 (mol/mol), 3 to 10 (mol/mol), 4 to 20 (mol/mol), 4 to 18 (mol/mol), 4 to 15 (mol/mol), 4 to 12 (mol/mol), 4 to 10 (mol/mol), 5 to 20 (mol/mol), 5 to 18 (mol/mol), 5 to 15 (mol/mol), 5 to 12 (mol/mol), 5 to 10 (mol/mol), 8 to 20 (mol/mol), 8 to 15 (mol/mol), 10 to 20 (mol/mol), 10 to 15 (mol/mol), 12 to 20 (mol/mol), 15 to 20 (mol/mol). In an embodiment of the invention, the hydrogenation agent is added in an amount such that the mole ratio of the hydrogenation agent to unsaturated double bond in the cyclic olefin polymer obtained from step (i) is in the range from 1 to 20 (mol/mol), more preferably in range of 2 to 15 (mol/mol), especially preferably 3 to 10 (mol/mol).

In some embodiments of the invention wherein the hydrogenation of the present invention is carried out by the hydrogenation agent, a co-agent will be added to prevent double bond oxidation. Such co-agent may be selected by a skilled person. In some embodiments of the invention, trialkyl amine, for example tri-C₁-C₁₀-alkyl amine, such as trimethylamine, triethylamine, tripropylamine, tributylamine, tripentylamine, trihexylamine, triheptylamine, trioctylamine, may be added as the co-agent to prevent double bond oxidation. In an embodiment of the invention, the co-agent is tripropylamine.

When the co-agent is used, the molar amount of the added co-agent is the same as the molar amount of the added hydrogenation agent.

Hydrogenation of the present invention may also be carried out by adding a hydrogenation catalyst and hydrogen to hydrogenate the carbon-carbon double bonds in the cyclic olefin polymer obtained from step (i).

The hydrogenation catalyst applicable for the present invention is not particularly limited, provided that it is capable of being generally used for hydrogenation of olefins and aromatic compounds. As specific examples of the hydrogenation catalyst, there can be a metal catalyst supported on a carrier, including those which comprise a transition metal such as palladium, platinum, nickel, rhodium or ruthenium supported on a carrier such as carbon, alumina, silica or diatomaceous earth.

In some embodiments of the invention, the hydrogenation catalyst is a homogeneous catalyst system consisting of a combination of a transition metal compound and an alkyl metal compound, such as cobalt acetate and triethylaluminum, nickel acetylacetonate and triisobutylaluminum, titanocene dichloride and n-butyllithium, zirconocene dichloride and sec-butyllithium, and tetrabutyl titanate and dimethyl magnesium. In some embodiments of the invention, the hydrogenation catalyst is a noble metal complex catalyst such as dichloro-bis(triphenylphosphine)palladium, chlorohydridocarbonyl tris(triphenylphosphine)ruthenium, and chlorotris(triphenylphosphine)rhodium.

For the hydrogenation of the present invention by adding a hydrogenation catalyst and hydrogen, the hydrogen pressure is usually in the range from 0.1 kg/cm² to 100 kg/cm², such as 0.1 kg/cm² to 90 kg/cm², 0.1 kg/cm² to 80 kg/cm², 0.1 kg/cm² to 70 kg/cm², 0.1 kg/cm² to 60 kg/cm², 0.1 kg/cm² to 50 kg/cm², 0.1 kg/cm² to 40 kg/cm², 0.1 kg/cm² to 30 kg/cm², 0.1 kg/cm² to 20 kg/cm², 0.5 kg/cm² to 90 kg/cm², 0.5 kg/cm² to 80 kg/cm², 0.5 kg/cm² to 70 kg/cm², 0.5 kg/cm² to 60 kg/cm², 0.5 kg/cm² to 50 kg/cm², 0.5 kg/cm² to 40 kg/cm², 0.5 kg/cm² to 30 kg/cm², 0.5 kg/cm² to 20 kg/cm², 1 kg/cm² to 90 kg/cm², 1 kg/cm² to 80 kg/cm², 1 kg/cm² to 70 kg/cm², 1 kg/cm² to 60 kg/cm², 1 kg/cm² to 50 kg/cm², 1 kg/cm² to 40 kg/cm², 1 kg/cm² to 30 kg/cm², 1 kg/cm² to 20 kg/cm². In an embodiment of the present invention, the hydrogen pressure is usually in the range from 0.5 kg/cm² to 70 kg/cm² and more preferably 1 kg/cm² to 50 kg/cm².

Hydrogenation temperature may be determined by a skilled person. In some embodiments of the invention, the hydrogenation temperature is usually in the range from −20° C. to 250° C., such as from −20° C. to 220° C., from −20° C. to 200° C., from −20° C. to 180° C., from −20° C. to 160° C., from −20° C. to 140° C., from −20° C. to 120° C., from −20° C. to 100° C., from −10° C. to 220° C., from −10° C. to 200° C., from −10° C. to 180° C., from −10° C. to 160° C., from −10° C. to 140° C., from −10° C. to 120° C., from −10° C. to 100° C., from 0° C. to 220° C., from 0° C. to 200° C., from 0° C. to 180° C., from 0° C. to 160° C., from 0° C. to 140° C., from 0° C. to 120° C., from 0° C. to 100° C., from 50° C. to 220° C., from 50° C. to 200° C., from 50° C. to 180° C., from 50° C. to 160° C., from 50° C. to 140° C., from 50° C. to 120° C., from 50° C. to 100° C., from 90° C. to 190° C., from 90° C. to 180° C., from 90° C. to 150° C., from 90° C. to 130° C., from 100° C. to 200° C., from 100° C. to 190° C., from 100° C. to 180° C., from 100° C. to 150° C., from 110° C. to 200° C., from 110° C. to 190° C., from 110° C. to 180° C., from 110° C. to 150° C., from 120° C. to 200° C., from 120° C. to 190° C., from 120° C. to 180° C., from 120° C. to 160° C.

In an embodiment of the invention, the hydrogenation temperature is usually in the range from 100° C. to 190° C., and more preferably 110° C. to 180° C.

In an embodiment of the invention, the hydrogenation temperature is in the range from −10° C. to 220° C. and more preferably from 0° C. to 200° C.

In some embodiments of the process of the present invention, the cyclic olefin polymer obtained from step (i) firstly undergoes separation, then the separated cyclic olefin polymer is hydrogenated in step (ii) by adding a hydrogenation catalyst and hydrogen or by adding a hydrogenation agent to hydrogenate the carbon-carbon double bonds in the obtained cyclic olefin polymer.

For separating the cyclic olefin polymer obtained from step (i), the cyclic olefin polymer will be precipitated, and may be further filtered, and dried.

Usually, step (ii) of the process of the present invention is carried out in an inert organic solvent. The organic solvent can be appropriately chosen depending upon solubility of the hydrogenation product. As specific examples of organic solvent, there can be toluene, xylene, tetrahydrofuran (THF) and dimethylformamide (DMF).

After completion of hydrogenation reaction, the polymerization catalyst and the hydrogenation catalyst or hydrogenation agent and their by-products are removed from the hydrogenation reaction solution. The metal catalyst supported on a carrier may be removed by filtration, the polymerization catalyst and hydrogenation agent and its by-product may be removed by a known process, including a process using an adsorbent for adsorptive removal.

After the removal of the polymerization catalyst and the hydrogenation catalyst or hydrogenation agent and their by-products, the obtained functional cyclic olefin polymer may be precipitated for example by pouring the obtained polymer solution into a large amount of acetone/DI water mixture, and then be collected by filtration, washed and dried.

### Application of the Functional Cyclic Olefin Polymer

The functional cyclic olefin polymer of the present invention may find its use in many applications.

High impact events can occur in applications such as coatings, structural adhesives and in fiber-reinforced composites, all of which commonly employ polymer glasses. The general focus for these applications is on molecules that can be used to form amorphous, glassy polymers because of the ease in processing into various shapes and composites. These applications typically require polymers with high modulus, high yield strength, and high impact strength. Several methods have been developed to overcome this trade-off in material properties including crystallization, addition of thermoplastic additives and rubber particles. However, these techniques can have drawbacks that include decreases in Tg, increases in cost, limitations in material processing or phase separation.

It is found that the functional cyclic olefin polymer of the present invention will provide improved mechanical performances, and it is applicable for applications such as coatings, structural adhesives and fiber-reinforced composites, to obtain coatings, structural adhesives and fiber-reinforced composites with improved mechanical performances, while removing such drawbacks as decreases in Tg, increases in cost, limitations in material processing, or phase separation.

The functional cyclic olefin polymer of the present invention will have a tensile modulus of 500 MPa to 4000 MPa, such as 500 MPa, 600 MPa, 700 MPa, 800 MPa, 900 MPa, 1000 MPa, 1100 MPa, 1200 MPa, 1300 MPa, 1400 MPa, 1500 MPa, 1600 MPa, 1700 MPa, 1800 MPa, 1900 MPa, 2000 MPa, 2100 MPa, 2200 MPa, 2300 MPa, 2400 MPa, 2500 MPa, 2600 MPa, 2700 MPa, 2800 MPa, 2900 MPa, 3000 MPa, 3100 MPa, 3200 MPa, 3300 MPa, 3400 MPa, 3500 MPa, 3600 MPa, 3700 MPa, 3800 MPa, 3900 MPa, 4000 MPa, or of any value between these values, as measured by universal tester (Gotech, Taiwan) according to IS037: 1994. In some embodiments of the invention, the functional cyclic olefin polymer has a tensile modulus in the range from 1000 MPa to 3000 MPa, such as in the range from 1500 MPa to 4000 MPa.

The functional cyclic olefin polymer of the present invention will have a tensile strength of 20 MPa to 100 MPa, such as 20 MPa, 30 MPa, 40 MPa, 50 MPa, 60 MPa, 70 MPa, 80 MPa, 90 MPa, 100 MPa, or of any value between these values as measured by universal tester (Gotech, Taiwan) according to IS037: 1994. In some embodiments of the invention, the functional cyclic olefin polymer has a tensile strength in the range from 25 MPa to 100 MPa, such as in the range from 30 MPa to 100 MPa.

The functional cyclic olefin polymer of the present invention will have an impact strength of 40 J/m to 100 J/m, such as 40 J/m, 50 J/m, 60 J/m, 70 J/m, 80 J/m, 90 J/m, 100 J/m, or of any value between these values, as measured by notch IZOD Impact test according to ASTM D 256 (method A, 23° C.). In some embodiments of the invention, the functional cyclic olefin polymer has an impact strength in the range from 50 J/m to 100 J/m, such as in the range from 60 MPa to 100 MPa.

One aspect of the present invention is a coating composition comprising the functional cyclic olefin polymer of the present invention.

In some embodiments of the present invention, the coating composition comprises a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group in monomer A of the present invention is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

In some embodiments of the present invention, the coating composition comprises a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof,

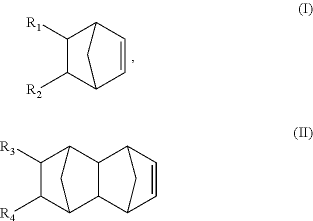

wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof, hydroxy; C₁-C₂₀-alkoxysilyl groups; C₆-C₂₀-aryloxysilyl; C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; halogen group; cyano; or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

One aspect of the present invention is a structural adhesive composition comprising the functional cyclic olefin polymer of the present invention.

In some embodiments of the present invention, the structural adhesive composition comprises a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group in monomer A of the present invention is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

In some embodiments of the present invention, the structural adhesive composition comprises a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof,

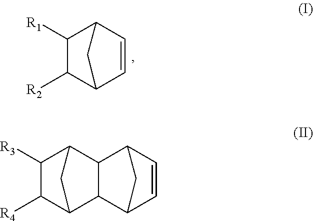

wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof; hydroxy; C₁-C₂₀-alkoxysilyl groups; C₆-C₂₀-aryloxysilyl; C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; halogen group; cyano; or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

One aspect of the present invention is a fiber-reinforced composite comprising the functional cyclic olefin polymer of the present invention.

In some embodiments of the present invention, the fiber-reinforced composite comprises a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group in monomer A of the present invention is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

In some embodiments of the present invention, the fiber-reinforced composite comprises a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group in monomer A of the present invention is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

In some embodiments of the present invention, the fiber-reinforced composite comprises a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof,

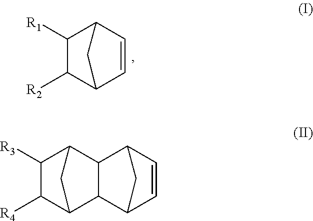

wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof, hydroxy; C₁-C₂₀-alkoxysilyl groups; C₆-C₂₀-aryloxysilyl; C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; halogen group; cyano; or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

It is further found that, when the polar functional group of monomer A is hydroxy, hydroxyalkyl group, the obtained functional cyclic olefin polymer of the present invention will also improve barrier properties, such as barrier properties against gases such as oxygen and against water vapor.

One aspect of the present invention is a barrier composition comprising the functional cyclic olefin polymer of the present invention, wherein the polar functional group of monomer A is hydroxy.

In some embodiments of the present invention, the barrier composition comprises a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof,

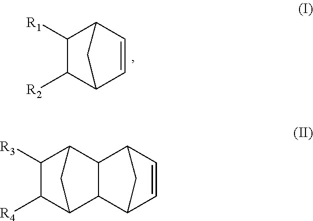

wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from hydroxy, hydroxymethyl, hydroxyethyl, hydroxypropyl, hydroxybutyl, hydroxypentyl, hydroxyhexyl, hydroxyheptyl, hydroxyoctyl, hydroxynonyl, hydroxy-C₁₂-alkyl, hydroxy-C₁₄-alkyl, hydroxy-C₁₆-alkyl, hydroxy-C₁₈-alkyl, hydroxy-C₂₀-alkyl, hydroxy-C₆-C₂₀-aryl, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer. For example, in an embodiment of the barrier composition of the invention, the cyclic olefin polymer is a homopolymer and the formed functional cyclic olefin polymer has Tg of between 70° C. to 160° C. In another embodiment of the barrier composition of the invention, the cyclic olefin polymer is a copolymer and the formed functional cyclic olefin polymer has Tg of between 0° C. to 160° C.

### EMBODIMENTS

The present disclosure comprises following embodiments.

1. A functional cyclic olefin polymer obtained from hydrogenation of a cyclic olefin polymer, wherein the cyclic olefin polymer comprises at least a monomeric unit A′ derived from a monomer A having a norbornene ring and a polar functional group,
wherein the amount of the monomeric unit A′ is in the range of from 20% to 100% by mole, 50% to 100% by mole, from 60% to 100% by mole, or from 70% to 100% by mole, based on the total amount of the monomeric units of the cyclic olefin polymer.

2. The functional cyclic olefin polymer of item 1, wherein the functional cyclic olefin polymer has a polar force in the range from 0.5 to 20 mN/m, preferably in the range from 0.5 to 15 mN/m, more preferably in the range from 0.5 to 10 mN/m.

3. The functional cyclic olefin polymer of item 1 or 2, wherein the polar functional group in monomer A is selected from aldehyde groups, alkylcarbonyloxy groups, arylcarbonyloxy groups, alkoxycarbonyl groups, aryloxycarbonyl groups, alkoxysilyl, aryloxysilyl, amine groups, amide groups, imide groups, hydroxy, hydroxyalkyl groups, hydroxyaryl groups, carboxyl groups, anhydride groups, halogen groups, cyano groups or a combination thereof.

4. The functional cyclic olefin polymer of item 1 or 2, wherein monomer A comprises or is selected from a monomer having Formula (I), a monomer having Formula (II), a dicyclopentadiene having a polar functional group, or a combination thereof,

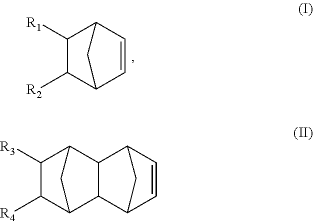

wherein R₁, R₂, R₃, R₄, independent from each other, represent a hydrogen atom, a polar functional group having a halogen, silicon, oxygen or nitrogen atom, or a hydrocarbon group having 1 to 20 carbon atoms, wherein at least one of R₁ and R₂ represents the polar functional group, and at least one of R₃ and R₄ represents the polar functional group.

5. The functional cyclic olefin polymer of item 4, wherein the polar functional group is selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof, hydroxy; C₁-C₂₀-alkoxysilyl groups, C₆-C₂₀-aryloxysilyl; C₁-C₂₀-alkylcarbonyloxy groups; C₆-C₂₀-arylcarbonyloxy groups; C₁-C₂₀-alkoxycarbonyl groups, C₆-C₂₀-aryloxycarbonyl; halogen group; cyano; or a combination thereof.

6. The functional cyclic olefin polymer of item 4, wherein the polar functional group is selected from hydroxy; hydroxy C₁-C₂₀-alkyl, hydroxy-C₆-C₂₀-aryl; carboxyl, carboxyl-C₁-C₂₀-alkyl, carboxyl-C₆-C₂₀-aryl, and anhydride groups thereof, C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; or a combination thereof.

7. The functional cyclic olefin polymer of item 4, wherein the polar functional group is selected from hydroxy, hydroxy C₁-C₂₀-alkyl, hydroxy-C₆-C₂₀-aryl, or a combination thereof.

8. The functional cyclic olefin polymer of item 1, wherein monomer A comprises or is selected from 5-norbornene-2-methanol, 5-norbornene-2,3-dicarboximide, 5-norbornene-2,3-dicarboxylic anhydride, 5-norbornene-2-carboxylic acid, 5-norbornene-2,3-dicarboxylic acid, 2,2-bis(hydroxymethyl)-5-norbornene, N-hydroxy-5-norbornene-2,3-dicarboxylic acid imide, 5-norbornene-2-carboxaldehyde, 5-norbornene-2-ol, methyl 5-norbornene-2-carboxylate, 5-norbornene-2-yl acetate, 8-methoxycarbonyl-tetracyclododecene, 8-methyl-8-methoxycarbonyl-tetracyclododecene, 8-hydroxymethyltetracyclododecene, tetracyclododecene-8,9-dicarboxylic acid, tetracyclododecene-8,9-dicarboxylic anhydride, 8-cyanotetracyclododecene, tetracyclododecene-8,9-dicarboxylic acid imide, 8-chlorotetracyclododecene, 8-trimethoxysilyl-tetracyclododecene, or a combination thereof.

9. The functional cyclic olefin polymer of any one of items 1 to 8, wherein the cyclic olefin polymer further comprises a monomeric unit B′ derived from a comonomer, wherein the comonomer is selected from cyclic olefins that do not have a functional group other than olefinic double bond.

10. The functional cyclic olefin polymer of any one of items 1 to 9, wherein the comonomer is selected from norbornene, norbornadiene, cyclopropene, cyclobutene, cyclopentene, methylcyclopentene, cyclohexene, methylcyclohexene, cycloheptene, cyclooctene (cis and trans), cyclopentadiene, cyclohexadiene, methylcyclohexadiene, cyclooctadiene, methylcyclooctadiene, phenylcyclooctadiene, 2-methyl-5-norbornene, 2-ethyl-5-norbornene, 2-butyl-5-norbornene, 2-hexyl-5-norbornene, dicyclopentadiene, 8-methyl-tetracyclododecene, 8-ethyltetracyclododecene, 8-cyclohexyltetracyclododecene, 8-cyclopentyl-tetracyclododecene, or a combination thereof.

11. A process for producing the functional cyclic olefin polymer of any one of items 1 to 10, comprising:
(i) polymerizing a monomer through ring-opening metathesis polymerization in the presence of a catalyst, to form a cyclic olefin polymer, wherein the monomer comprises at least a monomer A having a norbornene ring and a polar functional group; and
(ii) hydrogenating the cyclic olefin polymer.

12. The process of item 11, wherein step (i) is carried out in a solvent selected from dichloromethane, tetrahydrofuran, dimethylformamide, toluene, or xylene.

13. The process of item 12, wherein in step (i), the concentration of the monomer added for the polymerization is in the range from 0.01 mol/L to 5 mol/L, preferably in the range from 0.05 mol/L to 1 mol/L, more preferably in the range from 0.1 mol/L to 0.5 mol/L, based on the total volume of the monomer and the solvent.

14. The process of any one of items 11 to 13, wherein the catalyst in step (i) is an orgaoruthenium compound having formula of

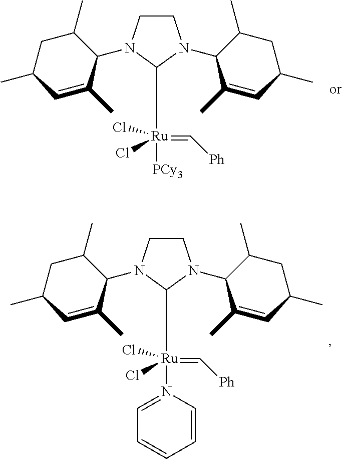

or the catalyst in step (i) is Grubbs 2nd catalyst.

15. The process of any one of items 11 to 14, wherein a vinyl compound is added at the end of step (i), preferably the vinyl compound is 1-butene, 1-pentene, 1-hexene, 1-octene, or ethyl vinyl ether, or a combination thereof.

16. The process of any one of items 11 to 15, wherein step (ii) is carried out by adding a hydrogenation agent or adding a hydrogenation catalyst and hydrogen to hydrogenate the carbon-carbon double bonds in the cyclic olefin polymer obtained from step (i), preferably the hydrogenation agent is p-toluenesulfonyl hydrazide.

17. The process of item 16, wherein the hydrogenation agent is added in an amount such that the mole ratio of the hydrogenation agent to unsaturated double bond in the cyclic olefin polymer obtained from step (i) is in the range from 1 to 20 (mol/mol), more preferably in range of 2 to 15 (mol/mol), especially preferably 3 to 10 (mol/mol).

18. The process of item 16 or 17, wherein trialkyl amine is further added in step (ii) when step (ii) is carried out by adding a hydrogenation agent, in the same molar amount as the hydrogenation agent, preferably the trialkyl amine is trimethylamine, triethylamine, tripropylamine, tributylamine, tripentylamine, trihexylamine, triheptylamine, trioctylamine, or a combination thereof.

19. The process of any one of claims 11 to 18, wherein the monomer further comprises a comonomer selected from cyclic olefins that do not have a functional group other than olefinic double bond, preferably the comonomer is selected from norbornene, norbornadiene, cyclopropene, cyclobutene, cyclopentene, methylcyclopentene, cyclohexene, methylcyclohexene, cycloheptene, cyclooctene (cis and trans), cyclopentadiene, cyclohexadiene, methylcyclohexadiene, cyclooctadiene, methylcyclooctadiene, phenylcyclooctadiene, 2-methyl-5-norbornene, 2-ethyl-5-norbornene, 2-butyl-5-norbornene, 2-hexyl-5-norbornene, dicyclopentadiene, 8-methyl-tetracyclododecene, 8-ethyltetracyclododecene, 8-cyclohexyltetracyclododecene, 8-cyclopentyl-tetracyclododecene, or a combination thereof.

20. A composition comprising the functional cyclic olefin polymer of any one of items 1 to 10 or the functional cyclic olefin polymer prepared by the process of any one of items 11 to 19.

21. A composition, comprising a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

22. A composition, comprising a functional cyclic olefin polymer obtained from hydrogenation of a cyclic olefin polymer, wherein the cyclic olefin polymer comprises at least a monomeric unit A′ derived from a monomer A, wherein monomer A comprises or is selected from a monomer having Formula (I), a monomer having Formula (II), a dicyclopentadiene having a polar functional group, or a combination thereof,

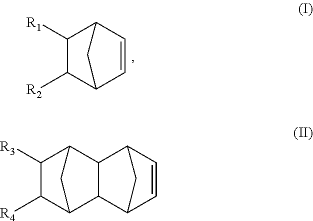

wherein R₁, R₂, R₃, R₄, independent from each other, represent a polar functional group, a hydrogen atom, or a hydrocarbon group having 1 to 20 carbon atoms, wherein at least one of R₁ and R₂ represents the polar functional group, and at least one of R₃ and R₄ represents the polar functional group,
wherein the polar functional group is independently selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof; hydroxy; C₁-C₂₀-alkoxysilyl groups; C₆-C₂₀-aryloxysilyl; C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; halogen group; cyano; or a combination thereof,
wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

23. The composition of any one of items 20 to 22, which is in form of a coating composition, a structural adhesive composition or a fiber-reinforced composite.

24. A barrier composition comprising the functional cyclic olefin polymer of any one of items 1 to 10, wherein the polar functional group of monomer A is hydroxy or hydroxyalkyl.

25. The barrier composition of item 24, wherein the cyclic olefin polymer is a homopolymer of monomer A and the formed functional cyclic olefin polymer has Tg of between 70° C. to 160° C., or the cyclic olefin polymer is a copolymer of monomer A and a comonomer and the formed functional cyclic olefin polymer has Tg of between 0° C. to 160° C.

26. The barrier composition of item 24 or 25, wherein monomer A is 5-norbornene-2-methanol, and the comonomer is selected from cyclic olefins that do not have a functional group other than olefinic double bond.

27. A barrier composition comprising a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof,

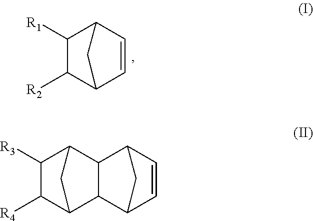

wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from hydroxy, hydroxy-C₁-C₂₀-alkyl, hydroxy-C₆-C₂₀-aryl, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

28. Use of the functional cyclic olefin polymer of any one of items 1 to 10 or the functional cyclic olefin polymer prepared by the process of any one of items 11 to 19, in a coating composition, a structural adhesive composition, a fiber-reinforced composite, or a barrier composition.

### EXAMPLES

The invention is further illustrated by following examples. The examples do not limit the scope of the invention as described and claimed.

### Method for Determining Glass Transition Temperature (T)

Tg was measured by raising the temperature at 10° C./min using a differential scanning calorimeter (DSC) or was measured with temperature ramp of 5° C./min within the range from −135° C. to 300° C. using dynamic mechanical thermal analysis (DMTA).

### Method for Determining Polar Force

The polar force was determined according to ASTM D7490-13 using water contact angle, wherein water contact angle was measured according to ASTM D 5946-04 by Drop Shape Analyzer (Kruss DSA 100, Germany).

### Method for Determining Decomposition Temperature (Td)

Td was measured by raising the temperature at 10° C./min using the thermogravimetric analyzer (TGA) of Pyris 1 TGA, PerkinElmer.

### Method for Testing Oxvgen Transmission Rate (OTR) and Water Vapor Transmission Rate (WVTR)

OTR was tested under ASTM D3985 of dry testing (23° C., 0% relative humidity (RH)). WVTR was tested under ASTM F1249 of 90% RH and 38° C. All inventive samples were formed by hot compression molding of the obtained functional cyclic olefin polymers into films with 100 μm thickness. For comparative samples, the OTR and WVTR parameters were obtained from the supplier or from open literature.

### Method for Determining Hydrogenation Percentage

Hydrogenation percentage was measured by NMR.

### Method for Determining Mechanical Properties

Tensile properties (tensile modulus, tensile strength @ max force, elongation @ max force) were measured by universal tester (Gotech, Taiwan) according to IS037: 1994. Impact strength was measured by notch IZOD Impact test according to ASTM D 256 (method A, 23° C.).

### Method for Determining M_{w} and Polydispersitv Index (PDI)

M_{w} and PDI were obtained by gel permeation chromatography (GPC) according to DIN 55672-1.

### Example 1: Functional Cyclic Olefin Polymer 1 Based on 5-Norbornene-2-Methanol

### 1. Ring-Opening Metathesis Polymerization

0.0625 mol 5-norbornene-2-methanol was dissolved in 125 ml DMF in Schlenk bottle, then N₂ was bubbled into the Schlenk bottle to remove oxygen and water for 1 hour.

0.0000625 mol Grubbs 2^{nd} catalyst (from Sigma-Aldrich) was added into 2 ml DCM, to give a catalyst solution. Then the catalyst solution was injected into the Schlenk bottle with vigorous stirring at room temperature for reaction time of 1 hour. Then 1 mL ethyl vinyl ether was added to terminate the polymerization.

The formed polymer was precipitated with Acetone/DI water (2:1 by volume) in an amount of 10 times by volume of the amount of the reaction solvent. Then the precipitated polymer was filtrated and continuously washed with acetone for about 24 hours, to obtain the cyclic olefin polymer 1.

### 2. Hydrogenation

The cyclic olefin polymer 1 was dried in a vacuum oven for 24 hours at 50° C., then re-dissolved in 500 mL DMF in a 1 L flask.

p-TSH (from Adamas Beta) in an amount of 5 times by mole of the amount of the cyclic olefin polymer 1 was charged into the flask, together with equivalent molar tripropylamine. N₂ was bubbled into the flask for 1 hour before heating up the system. Then the system was heated to 130° C. for hydrogenation for 5 hours.

Then the system was cooled down to room temperature. The formed polymer was precipitated with Acetone/DI water (2:1 by volume) in an amount of 10 times by volume of the amount of the reaction solvent. Then the precipitated polymer was continuously washed with Acetone/DI water (2:1 by volume) for 3 days. Then the precipitated polymer was filtrated and dried in a vacuum oven for 48 hours at 50° C., to obtain the functional cyclic olefin polymer 1.

The obtained hydrogenation percentage was greater than 99%.

### 3. Characterization

The functional cyclic olefin polymer 1 was characterized in term of the glass transition temperature (Tg) (by DSC), the decomposition temperature (Td), and the polar force, by the methods stated above. Results were shown in table 4.

### Example 2 Functional Cyclic Olefin Polymer 2 Based on 5-Norbornene-2-Yl Acetate

### 1. Ring-Opening Metathesis Polymerization

Ring-opening metathesis polymerization of example 2 was the same as that of example 1, except that 5-Norbornene-2-yl acetate was used instead of 5-norbornene-2-methanol, solvent was THF, and the reaction time was 15 min.

2. Hydrogenation: Hydrogenation of example 2 was the same as that of example 1, except that the solvent was xylene. The obtained hydrogenation percentage was greater than 99%.

3. Characterization: The functional cyclic olefin polymer 2 was characterized in term of the glass transition temperature (Tg) (by DSC), the decomposition temperature (Td), the polar force, M_{w} and PDI, by the methods stated above. Results were shown table 4.

### Example 3 Functional Cyclic Olefin Polymer 3 Based on Cyclooctene and 5-Norbornene-2-Methanol

1. Ring-opening metathesis polymerization: Ring-opening metathesis polymerization of example 3 was the same as that of example 1, except that 0.0625 mol cyclooctene and 0.0125 mol 5-norbornene-2-methanol were used instead of 0.0625 mol 5-norbornene-2-methanol; 125 mL THF were used instead of 125 ml DMF; the catalyst solution was prepared by charging 0.00008 mol of Grubbs 2nd catalyst into 2 ml of DCM; and the reaction time was 90 minutes.

2. Hydrogenation: Hydrogenation of example 3 was the same as that of example 1, except that the solvent was xylene. The obtained hydrogenation percentage was greater than 99%.

3. Characterization: The functional cyclic olefin polymer 3 was characterized in term of the glass transition temperature (Tg) (by DMTA), the decomposition temperature (Td), the polar force, M_{w} and PDI. Results were shown in table 4.

### Example 4 Functional Cyclic Olefin Polymer 4 Based on 5-Norbornene-2-Methanol

A glassware reactor of 250 ml equipped with a stirrer was charged with 11.642 g 5-norbornene-2-methanol and 123 ml DMF, into which a solution of 0.0824 g Benzylidene[1,3-bis(2,4,6-trimethylphenyl)-2-imidazolidinylidene]dichloro(tricyclohexylphosphine)ruthenium compound in 2 ml DMF was added to initiate the ring-opening metathesis polymerization. The ring-opening metathesis polymerization was carried out at 25° C. for 1 hour. After that, 5 ml ethyl vinyl ether was added to the reactor to terminate the polymerization. Then 58.21 g p-TSH and 44.78 g Tri-n-propylamine were added with 300 ml DMF into the reactor for hydrogenation reaction. The hydrogenation reaction was carried out at temperature of 150° C. for 5 hours. After the completion of the hydrogenation reaction, the reactor content was cooled to room temperature and 300 ml DMF was added for dilution. Then the reactor content was poured into a large amount of acetone/DI water (2:1 by volume) to precipitate the formed polymer. The polymer was then collected by filtration, washed with acetone and dried under reduced pressure at 50° C. for 48 hours, to obtain the functional cyclic olefin polymer 4. The obtained hydrogenation percentage was greater than 99%.

Glass transition temperature (Tg) (by DMTA), the decomposition temperature (Td), the polar force of the functional cyclic olefin polymer 4 were provided in table 4.

The dried functional cyclic olefin polymer 4 was compression molded into a film of 100 μm thick for OTR and WVTR test. The obtained results were compared with conventional EVOH resin and COC resin. Results were shown in table 1.

TABLE 1
Functional cyclic olefin polymer
4, EVOH resin and COC properties

| | | OTR | WVTR |
|---|---|---|---|
| | Tg | (23° C./0% RH) | (38° C./90% RH) |
| | (° C.) | cc-mil/m² day atm | g-mil/m² day atm |
| EVOH resin¹ | 50-63 | 0.3-1.2 | 23-60 |
| Functional cyclic | 100.5 | 4.8-5.2 | 7.2-8.0 |
| olefin polymer 4² | | | |
| COC³ | 50-185 | 1000 | 1-2 |

¹The data related to OTR and WVTR of EVOH resin were obtained from Barry A. Morris, (2017) The Science and Technology of Flexible Packaging, table 8.6 in page 270, Elsevier Inc.
²Functional cyclic olefin polymer 4 was tested with the sample of 100 μm thick.
³A copolymer of cyclic olefin and ethylene, the data related to OTR and WVTR of which were obtained from Barry A. Morris (2017) The Science and Technology of Flexible Packaging, table 8.6 in page 270, Elsevier Inc.

It can be seen from table 1 that the hydrogenated product of NB—CH₂OH homopolymer has similar OTR and improved WVTR as compared with EVOH resin, and has much better OTR than conventional non-polar COC product.

### Example 5 Functional Cyclic Olefin Polymer 5 Based on Cyclooctene and 5-Norbornene-2-Methanol

A glassware reactor of 250 ml equipped with a stirrer was charged with 2.58 g 5-norbornene-2-methanol and 6.89 g cyclooctene, together with 123 ml THF, into which a solution of 0.0705 g Benzylidene[1,3-bis(2,4,6-trimethylphenyl)-2-imidazolidinylidene]dichloro(tricyclohexylphosphine) ruthenium compound in 2 ml DMF was added to initiate the ring-opening metathesis polymerization. The ring-opening metathesis polymerization was carried out at 25° C. for 1.5 hours. After that, 5 ml ethyl vinyl ether was added to the reactor to terminate the polymerization. Then 47.35 g p-TSH and 36.4 g Tri-n-propylamine were added with 500 ml xylene into the reactor for hydrogenation reaction while evaporating THF. The hydrogenation reaction was carried out at temperature of 150° C. for 5 hours. After the completion of the hydrogenation reaction, the reactor content was cooled to room temperature and 300 ml DMF was added for dilution. Then the reactor content was poured into a large amount of acetone/DI water (2:1 by volume) to precipitate the formed polymer. The polymer was then collected by filtration, washed with acetone and dried under reduced pressure at 50° C. for 48 hours, to obtain the functional cyclic olefin polymer 5. The obtained hydrogenation percentage was greater than 99%.

Glass transition temperature (Tg) (by DMTA), the decomposition temperature (Td), the polar force, M_{w} and PDI of the functional cyclic olefin polymer 5 were provided in table 4.

The dried functional cyclic olefin polymer 5 was compression molded into a film of 100 μm thick for OTR and WVTR test. The obtained results were compared with conventional PE resin. Results were shown in table 2.

TABLE 2
Functional cyclic olefin polymer 5 and PE properties

| | | OTR | WVTR |
|---|---|---|---|
| | Tg | (23° C./0% RH) | (38° C./90% RH) |
| | (° C.) | cc-mil/m² day atm | g-mil/m² day atm |
| PE¹ | −100 | 1600-2300 | 4-12 |
| Functional cyclic | −60.7 | 1428 | 21.6 |
| olefin polymer 5² | | | |

¹HDPE, the data related to OTR and WVTR of which were obtained from Barry A. Morris (2017) The Science and Technology of Flexible Packaging, table 8.6, pg. 270, Elsevier Inc..
²Functional cyclic olefin polymer 5 was tested with the sample of 100 μm thick

### Example 6 Mechanical Properties of the Functional Cyclic Olefin Polymers

Properties of hydrogenated poly (norbornene) (sample P—NB), hydrogenated poly (5-norbornene-2-methanol) (sample p-NBCH₂OH), hydrogenated poly (5-norbornene-2-carboxylic acid) (sample p-NBCOOH), hydrogenated poly (5-norbornene-2-carboxylate) (sample p-NBCOOMe) and hydrogenated poly (5-norboenene-2-yl acetate) (sample p-NBOAc) were compared in example 6, wherein sample p-NBCH₂OH is obtained from example 1, sample p-NBOAc was obtained from example 2. Other samples in example 6 were prepared with the same procedure of example 1, except that the monomers were replaced by 5-norbornene-2-COOH, 5-norbornene-2-COOMe, and norbornene, respectively. The obtained hydrogenation percentage was greater than 99%.

Tensile strength and modulus of hydrogenated poly (norbornene) (sample P—NB), hydrogenated poly (5-norbornene-2-methanol) (sample p-NBCH₂OH), hydrogenated poly (5-norbornene-2-carboxylic acid) (sample p-NBCOOH), hydrogenated poly (5-norbornene-2-carboxylate) (sample p-NBCOOMe) and hydrogenated poly (5-norboenene-2-yl acetate) (sample p-NBOAc) were measured respectively. Results were provided in table 3.

Glass transition temperature (Tg) (by DMTA), the decomposition temperature (Td), the polar force of sample p-NB, sample p-NBCH₂OH, sample p-NBCOOH, sample p-NBCOOMe and sample p-NBOAc of example 6 were provided in table 4. M_{w} and PDI of sample p-NB and sample p-NBOAc of example 6 were provided in table 4.

TABLE 3

| | Tensile modulus, | Tensile strength @ | Elongation @ |
|---|---|---|---|
| Sample | Mpa | max force, Mpa | max force, % |
| p-NBCOOH | 3074 | 77 | 5 |
| p-NBCH₂OH | 2416 | 56 | 5 |
| p-NBOAc | 1935 | 40 | 4 |
| p-NBCOOMe | 1818 | 38 | 3 |
| p-NB | 368 | 13 | 33 |

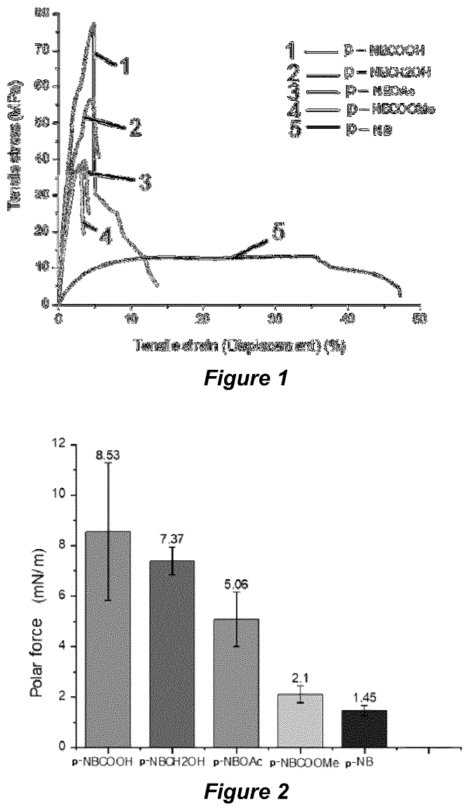

FIG. 1 shows the tensile properties of each sample of example 6. FIG. 2 shows the polar forces of each sample of example 6.

It can be seen that, the introduction of functional groups (—CH₂OH, —COOH, —OAc, —COOMe) greatly improves the tensile strength and tensile modulus as compared to hydrogenated poly (norbornene) without functional groups. Among these samples, hydrogenated poly (5-norbornene-2-carboxylic acid) achieves highest tensile strength and modulus.

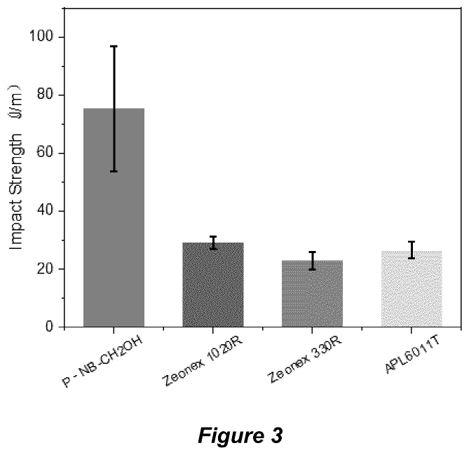

Furthermore, the impact property of the functional cyclic olefin polymer of the present invention was also improved. Impact properties of the functional cyclic olefin polymers of the present invention were illustrated in FIG. 3.

As shown in FIG. 3, by introducing polar functional group, hydrogenated poly (5-norbornene-2-methanol) (the functional cyclic olefin polymer of the present invention) has improved impact strength of 75.3 J/m as compared with commercial cyclic olefin copolymers (Zeonex 1020R and Zeonex 33R commercially available from Zeon Corporation, Japan, and APL6011T, commercially available from Mitsui Chemicals, Inc., Japan), which has impact strength of 29.1 J/m, 22.9 J/m and 26.7 J/m respectively.

TABLE 4

| Functional cyclic | Mw, | | Tg, | Td, | polar force |
|---|---|---|---|---|---|
| olefin polymer | Kg/mol | PDI | ° C. | ° C. | mN/m |
| Example 1 | — | — | 111.5 | 486.4 | 7.37 ± 2.72 |
| Example 2 | 42.3 | 6.07 | 39.3 | 331.7 | 5.06 ± 1.08 |
| Example 3 | 89.1 | 1.98 | −65.0 | 466.8 | 3.99 ± 0.83 |
| Example 4 | — | — | 100.5 | 479.8 | 7.25 ± 1.04 |
| Example 5 | 130.9 | 2.60 | −60.7 | 469.8 | 3.41 ± 0.66 |
| Example 6 P-NBCOOH | — | — | 154.8 | 385.0 | 8.53 ± 0.55 |
| Example 6 P-NBCH₂OH | — | — | 111.5 | 486.4 | 7.37 ± 2.72 |
| Example 6 P-NBOAc | 42.3 | 6.07 | 39.3 | 331.7 | 5.06 ± 1.08 |
| Example 6 P-NBCOOMe | — | — | 37.6 | 454.4 | 2.10 ± 0.34 |
| Example 6 P-NB | 28.2 | 4.44 | 6.0 | 481.0 | 1.45 ± 0.20 |

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A functional cyclic olefin polymer obtained from hydrogenation of a cyclic olefin polymer, wherein the cyclic olefin polymer comprises at least a monomeric unit A′ derived from a monomer A having a norbornene ring and a polar functional group,
wherein the amount of the monomeric unit A′ is in the range of from 20% to 100% by mole, 50% to 100% by mole, from 60% to 100% by mole, or from 70% to 100% by mole, based on the total amount of the monomeric units of the cyclic olefin polymer.

2. The functional cyclic olefin polymer of claim 1, wherein the functional cyclic olefin polymer has a polar force in the range from 0.5 to 20 mN/m.

3. The functional cyclic olefin polymer of claim 1, wherein the polar functional group in monomer A is selected from aldehyde groups, alkylcarbonyloxy groups, arylcarbonyloxy groups, alkoxycarbonyl groups, aryloxycarbonyl groups, alkoxysilyl, aryloxysilyl, amine groups, amide groups, imide groups, hydroxy, hydroxyalkyl groups, hydroxyaryl groups, carboxyl groups, anhydride groups, halogen groups, cyano groups or a combination thereof.

4. The functional cyclic olefin polymer of claim 1, wherein the monomer A comprises or is selected from a monomer having Formula (I), a monomer having Formula (II), a dicyclopentadiene having a polar functional group, or a combination thereof, 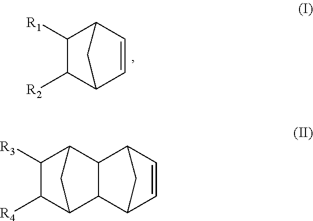
wherein R₁, R₂, R₃, R₄, independent from each other, represent a hydrogen atom, a polar functional group having a halogen, silicon, oxygen or nitrogen atom, or a hydrocarbon group having 1 to 20 carbon atoms, wherein at least one of R₁ and R₂ represents the polar functional group, and at least one of R₃ and R₄ represents the polar functional group.

5. The functional cyclic olefin polymer of claim 4, wherein the polar functional group is selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof, hydroxy; C₁-C₂₀-alkoxysilyl groups, C₆-C₂₀-aryloxysilyl; C₁-C₂₀-alkylcarbonyloxy groups; C₆-C₂₀-arylcarbonyloxy groups; C₁-C₂₀-alkoxycarbonyl groups, C₆-C₂₀-aryloxycarbonyl; halogen group; cyano; or a combination thereof.

6. The functional cyclic olefin polymer of claim 4, wherein the polar functional group is selected from hydroxy; hydroxy C₁-C₂₀-alkyl, hydroxy-C₆-C₂₀-aryl; carboxyl, carboxyl-C₁-C₂₀-alkyl, carboxyl-C₆-C₂₀-aryl, and anhydride groups thereof, C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; or a combination thereof.

7. The functional cyclic olefin polymer of claim 4, wherein the polar functional group is selected from hydroxy, hydroxy C₁-C₂₀-alkyl, hydroxy-C₆-C₂₀-aryl, or a combination thereof.

8. The functional cyclic olefin polymer of claim 1, wherein the monomer A comprises or is selected from 5-norbornene-2-methanol, 5-norbornene-2,3-dicarboximide, 5-norbornene-2,3-dicarboxylic anhydride, 5-norbornene-2-carboxylic acid, 5-norbornene-2,3-dicarboxylic acid, 2,2-bis(hydroxymethyl)-5-norbornene, N-hydroxy-5-norbornene-2,3-dicarboxylic acid imide, 5-norbornene-2-carboxaldehyde, 5-norbornene-2-ol, methyl 5-norbornene-2-carboxylate, 5-norbornene-2-yl acetate, 8-methoxycarbonyl-tetracyclododecene, 8-methyl-8-methoxycarbonyl-tetracyclododecene, 8-hydroxymethyltetracyclododecene, tetracyclododecene-8,9-dicarboxylic acid, tetracyclododecene-8,9-dicarboxylic anhydride, 8-cyanotetracyclododecene, tetracyclododecene-8,9-dicarboxylic acid imide, 8-chlorotetracyclododecene, 8-trimethoxysilyl-tetracyclododecene, or a combination thereof.

9. The functional cyclic olefin polymer of claim 1, wherein the cyclic olefin polymer further comprises a monomeric unit B′ derived from a comonomer, wherein the comonomer is selected from cyclic olefins that do not have a functional group other than olefinic double bond.

10. The functional cyclic olefin polymer of claim 1, wherein the comonomer is selected from norbornene, norbornadiene, cyclopropene, cyclobutene, cyclopentene, methylcyclopentene, cyclohexene, methylcyclohexene, cycloheptene, cyclooctene (cis and trans), cyclopentadiene, cyclohexadiene, methylcyclohexadiene, cyclooctadiene, methylcyclooctadiene, phenylcyclooctadiene, 2-methyl-5-norbornene, 2-ethyl-5-norbornene, 2-butyl-5-norbornene, 2-hexyl-5-norbornene, dicyclopentadiene, 8-methyl-tetracyclododecene, 8-ethyltetracyclododecene, 8-cyclohexyltetracyclododecene, 8-cyclopentyl-tetracyclododecene, or a combination thereof.

11. A process for producing the functional cyclic olefin polymer of claim 1, comprising:
(i) polymerizing a monomer through ring-opening metathesis polymerization in the presence of a catalyst, to form a cyclic olefin polymer, wherein the monomer comprises at least a monomer A having a norbornene ring and a polar functional group; and
(ii) hydrogenating the cyclic olefin polymer.

12. The process of claim 11, wherein step (i) is carried out in a solvent selected from dichloromethane, tetrahydrofuran, dimethylformamide, toluene, or xylene.

13. The process of claim 12, wherein in step (i), the concentration of the monomer added for the polymerization is in the range from 0.01 mol/L to 5 mol/L.

14. The process of claim 11, wherein the catalyst in step (i) is an orgaoruthenium compound having formula of; 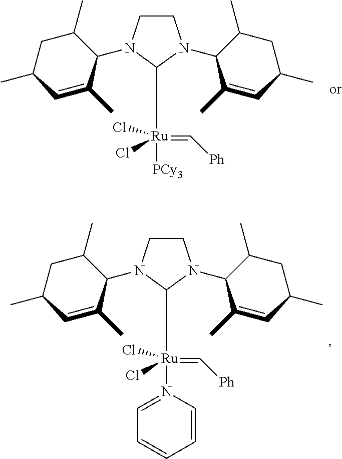
or the catalyst in step (i) is Grubbs 2nd catalyst.

15. The process of claim 11, wherein a vinyl compound is further added at the end of step (i.

16. The process of claim 11, wherein step (ii) is carried out by adding a hydrogenation agent or adding a hydrogenation catalyst and hydrogen to hydrogenate the carbon-carbon double bonds in the cyclic olefin polymer obtained from step (i).

17. The process of claim 16, wherein the hydrogenation agent is added in an amount such that the mole ratio of the hydrogenation agent to unsaturated double bond in the cyclic olefin polymer obtained from step (i) is in the range from 1 to 20 (mol/mol).

18. The process of claim 16, wherein trialkyl amine is further added in step (ii) when step (ii) is carried out by adding a hydrogenation agent, in the same molar amount as the hydrogenation agent, preferably the trialkyl amine is trimethylamine, triethylamine, tripropylamine, tributylamine, tripentylamine, trihexylamine, triheptylamine, trioctylamine, or a combination thereof.

19. The process of any one of claim 11, wherein the monomer further comprises a comonomer selected from norbornene, norbornadiene, cyclopropene, cyclobutene, cyclopentene, methylcyclopentene, cyclohexene, methylcyclohexene, cycloheptene, cyclooctene (cis and trans), cyclopentadiene, cyclohexadiene, methylcyclohexadiene, cyclooctadiene, methylcyclooctadiene, phenylcyclooctadiene, 2-methyl-5-norbornene, 2-ethyl-5-norbornene, 2-butyl-5-norbornene, 2-hexyl-5-norbornene, dicyclopentadiene, 8-methyl-tetracyclododecene, 8-ethyltetracyclododecene, 8-cyclohexyltetracyclododecene, 8-cyclopentyl-tetracyclododecene, or a combination thereof.

20. (canceled)

21. A composition, comprising a functional cyclic olefin polymer obtained from hydrogenation of a cyclic olefin polymer, wherein the cyclic olefin polymer comprises at least a monomeric unit A′ derived from a monomer A having a norbornene ring and a polar functional group, wherein the polar functional group is selected from hydroxy, hydroxyalkyl group, hydroxyaryl group, carboxyl, alkylcarbonyloxy, arylcarbonyloxy, aryloxycarbonyl, alkoxycarbonyl such as —COOCH₃, or a combination thereof, wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

22. A composition, comprising a functional cyclic olefin polymer obtained from hydrogenation of a cyclic olefin polymer, wherein the cyclic olefin polymer comprises at least a monomeric unit A′ derived from a monomer A, wherein monomer A comprises or is selected from a monomer having Formula (I), a monomer having Formula (II), a dicyclopentadiene having a polar functional group, or a combination thereof, 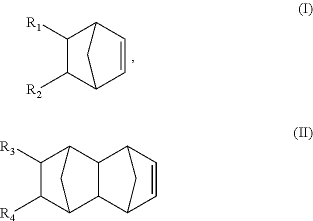
wherein R₁, R₂, R₃, R₄, independent from each other, represent a polar functional group, a hydrogen atom, or a hydrocarbon group having 1 to 20 carbon atoms, wherein at least one of R₁ and R₂ represents the polar functional group, and at least one of R₃ and R₄ represents the polar functional group,
wherein the polar functional group is independently selected from C₁-C₂₀-alkanal groups; C₆-C₂₀-aryl aldehyde groups; hydroxy-C₁-C₂₀-alkyl, hydroxy-C₆-C₂₀-aryl; imide groups; carboxyl, carboxyl-C₁-C₂₀-alkyl, carboxyl-C₆-C₂₀-aryl, and anhydride groups thereof, hydroxy; C₁-C₂₀-alkoxysilyl groups; C₆-C₂₀-aryloxysilyl; C₁-C₂₀-alkylcarbonyloxy groups; C₆-C₂₀-arylcarbonyloxy groups; C₁-C₂₀-alkoxycarbonyl groups; C₆-C₂₀-aryloxycarbonyl; halogen group; cyano; or a combination thereof,
wherein the amount of the monomeric unit A′ is in the range from 20% to 100% by mole, 50% to 100% by mole, from 60% to 100% by mole, or from 70% to 100% by mole, based on the total amount of the monomeric units of the cyclic olefin polymer.

23.-26. (canceled)

27. A barrier composition comprising a functional cyclic olefin polymer obtained from hydrogenation of a cyclic olefin polymer, wherein the cyclic olefin polymer comprises at least a monomeric unit A′ derived from monomer A, wherein the monomer A comprises or is selected from a monomer having Formula (I), a monomer having Formula (II), a dicyclopentadiene having a polar functional group, or a combination thereof, 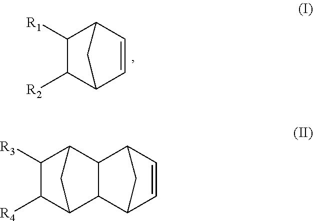
wherein R₁, R₂, R₃, R₄, independent from each other, represent a polar functional group, a hydrogen atom, or a hydrocarbon group having 1 to 20 carbon atoms, such as 2, 3, 4, 5, 6, 7, 8, 9, 10, 12, 15, 16 and 18 carbon atoms, wherein at least one of R₁ and R₂ represents the polar functional group, and at least one of R₃ and R₄ represents the polar functional group,
wherein the polar functional group is independently selected from hydroxy, hydroxy-C₁-C₂₀-alkyl, hydroxy-C₆-C₂₀-aryl, or a combination thereof, wherein the amount of the monomeric unit A′ is in the range from 20 to 100% by mole, 50 to 100% by mole, from 60 to 100% by mole, or from 70 to 100% by mole, based on the total amount of the monomeric units of the cyclic olefin polymer.

28. (canceled)
